(19) United States
(12) Patent Application Publication
(10) Pub. No.: US 2006/0042734 A1
(43) Pub. Date: Mar. 2, 2006

(54) Wear component and warning system

(76) Inventors: Douglas D. Turner, Lake Orion, MI (US); Laurence F. Matola, Lake Orion, MI (US); Jeffrey D. Higgins, Dexter, MI (US)

Correspondence Address: DELPHI TECHNOLOGIES, INC., M/C 480-410-202, PO BOX 5052, TROY, MI, 48007, US

(21) Appl. No.: 10/924,410

(22) Filed: Aug. 24, 2004

(51) Int. Cl. B60C 11/24

(52) U.S. Cl. 152/154.2; 152/152.1; 188/1.11 L; 340/454

(57) ABSTRACT

A wear component includes an acceptable wear portion, a marginal wear portion, and a sensor disposed below the acceptable wear portion and configured to generate a condition signal in response to an energizing signal.

### BACKGROUND

Wear components, such as tire tread and brake pads, are components that are worn by wearing surfaces, such as pavement and brake rotors. At some point, wear components are so worn that their continued use may be dangerous.

For example, tire tread eventually wears out to dangerous levels. Today, the only method of detection for low tire tread is a visual inspection of the remaining tread depth. This method may prove unsatisfactory as many people do not know how to perform a visual inspection. Furthermore, those individuals that do know how to perform a visual inspection of tire tread often do not do so with any amount of regularity. If a vehicle is operated without proper tire tread depth, the vehicle, its occupants, and those people and property in the vehicle's vicinity are in potential danger.

In addition to tires, brake pads also wear out after a period of use. However, in contrast to tire wear, several options currently exist to notify the driver that a brake pad needs to be replaced. One such method employs mechanical techniques to create an audible signal notifying the driver that the brake pad needs to be replaced. This solution is noisy and can be disturbing to the driver and those around the vehicle. Another brake pad wear notification technique incorporates a conductive element that is built into the brake pad and subsequently wired back to a processor that monitors connectivity of the conductive element. When the brake pad wears down, the conductive element is destroyed. The processor senses the destruction and warns the driver through a human machine interface (HMI). An example of the driver interface could be an indicator in the instrument cluster. This driver interface is more user friendly than the previously mentioned method, although costly and complicated electrical content is required. Indeed, all of the above-mentioned methods are complex and/or expensive in that they require direct electrical connections to the wear component.

### SUMMARY

A wear component includes an acceptable wear portion, a marginal wear portion, and a wireless sensor that is disposed in a predetermined location in the wear component based on the destructive properties of the wear component. While the wireless sensor remains in operation and in place in the wear component, the wireless sensor receives an energizing signal from a transmitter. The energizing signal powers the wireless sensor and allows it to generate a condition signal. While the wireless sensor transmits the condition signal in response to the energizing signal, the wear component is said to be within its acceptable wear period. When the acceptable wear portion is worn away, the wireless sensor becomes exposed and is destroyed or rendered inoperable, such that the wireless sensor no longer transmits the condition signal in response to the energizing signal. When it is determined that the wireless sensor is no longer transmitting the condition signal in response to the energizing signal, a warning is provided to a user.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a schematic view of an exemplary wear component warning system.

FIG. 2 is a schematic view of an exemplary brake pad warning system.

FIG. 3 is a flowchart illustrating an exemplary method of detecting brake pad wear.

FIG. 4 is a schematic view of an exemplary brake pad warning system in which an RF signal is generated by a magnet.

FIG. 5A is a schematic view of an exemplary brake pad warning system that makes use of tire pressure warning system components.

FIG. 5B is a schematic view of another exemplary brake pad warning system that makes use of tire pressure warning system components.

FIG. 6 is a schematic view of an exemplary brake pad warning system that includes a processor external to a vehicle.

FIG. 7 is a schematic view of an exemplary tire tread warning system that makes use of a tire pressure monitoring system.

FIG. 8 is a schematic view of an exemplary tire tread warning system.

FIG. 9 is a schematic view of an exemplary tire tread warning system that in which an RF signal is generated by a magnet.

FIG. 10 is a flowchart illustrating and exemplary method of a sign-up process for multiple sensors having unique IDs in a vehicle.

Throughout the drawings, identical reference numbers designate similar, but not necessarily identical, elements.

### DETAILED DESCRIPTION

Several exemplary wear component warning systems are discussed herein, including brake pad warning systems and tire tread warning systems which provide information about the condition of a wear component without having direct electrical wiring to the sensor. As a result, the exemplary wear component warning systems allow for the relatively simple and inexpensive monitoring of a variety of wear components.

The present systems monitor the condition of a wear component by providing a signal, such as a RF energizing signal to a sensor, such as a radio frequency identification tag (RFID), that is positioned in a predetermined location in the wear component based on the destructive properties of the wear component. For example, in one embodiment, the RFID tag may be embedded below the acceptable wear portion of the wear component. So long as the RFID tag remains functional and undamaged in any way in the wear component, the RFID tag will transmit a condition signal in response to the RF energizing signal. A processor monitors the transmission of the condition signal. When the processor determines that the RFID tag is not transmitting a condition signal in response to the RF energizing signal, the processor provides a warning to a user that the wear component should be inspected and/or replaced.

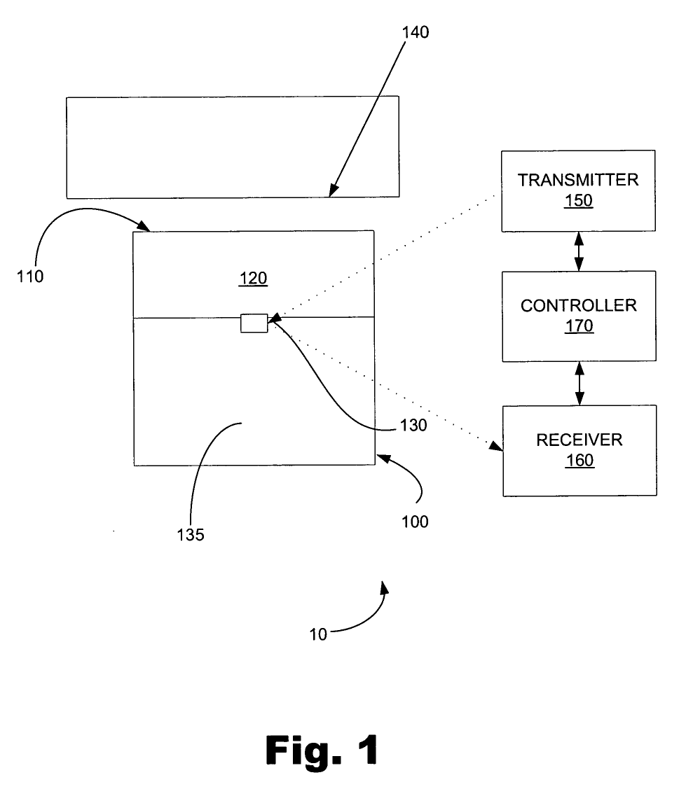

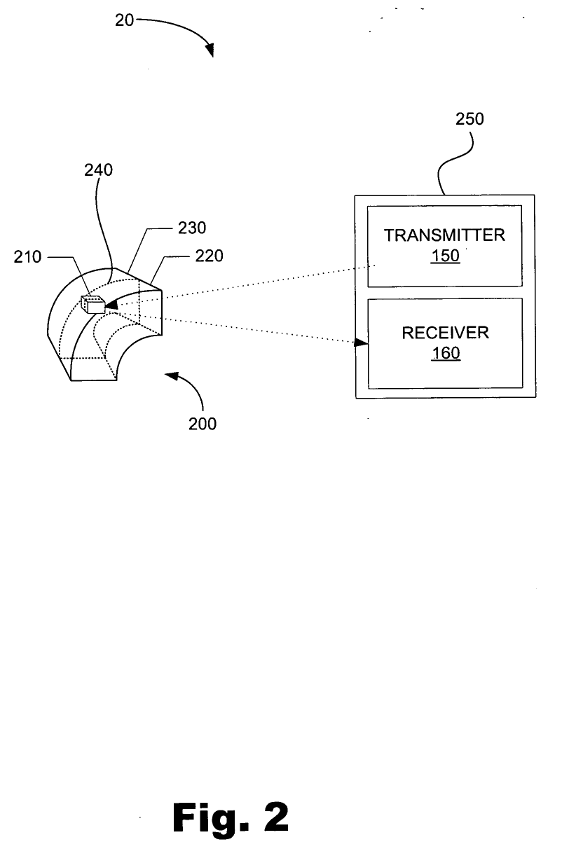

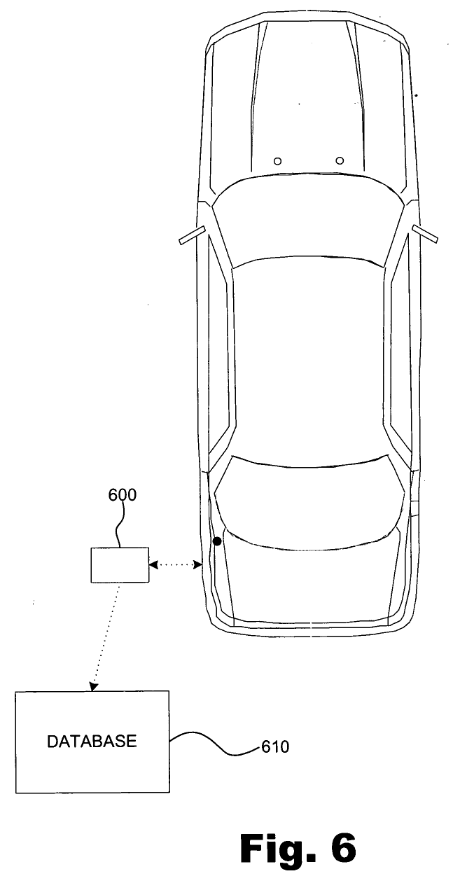

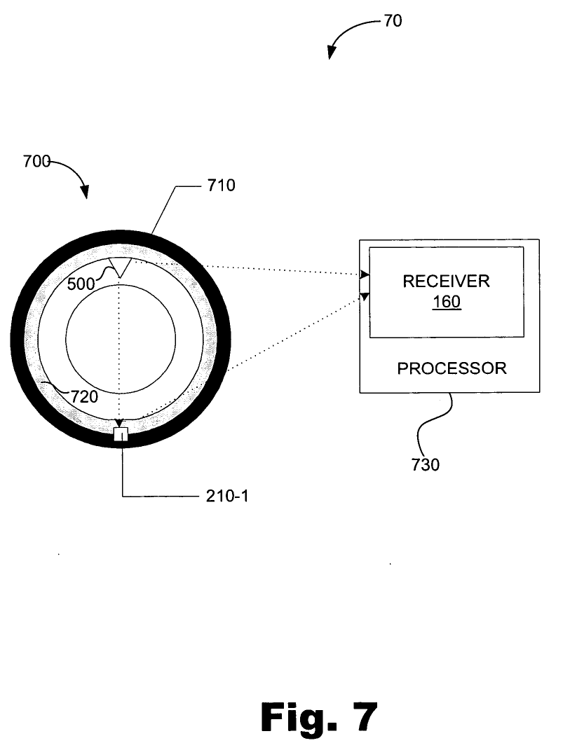

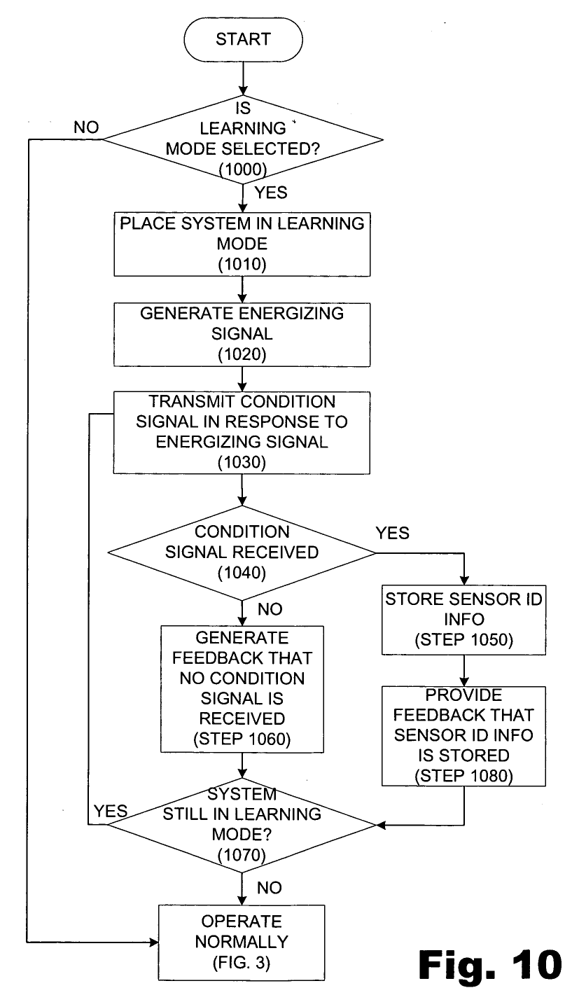

In the present specification, a general wear component warning system will first be discussed with reference to FIG. 1. Thereafter, several brake pad warning systems will be discussed with reference to FIGS. 2-5, followed by a brief discussion of an external monitoring system that can be adapted for use with brake pad warning systems and/or tire tread warning systems, as shown in FIG. 6. A detailed discussion of several tire tread warning systems will then follow with reference to FIGS. 7-9. A sign-up process for identifying multiple sensors having unique IDs is described in connection with FIG. 10.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Wear Component Warning System

FIG. 1 is a schematic view of a wear component warning system (10) as applied to a wear component (100). The wear component (100) includes a wear surface (110) having an acceptable wear portion (120). The wear component (100) also includes a wireless sensor (130) that is positioned within the wear component (100) at a predetermined location based on the destructive properties of the wear component (100). In one embodiment, the sensor (130) is embedded in the wear component (100) at least partially below the acceptable wear portion (120). However, it is understood that the location of the sensor (130) may be varied according to the determination of the depth of the acceptable wear portion (120) and the destructive properties of the wear component (100). For example, if the wear component (100) is a brake pad, it is understood that brake pads will get hot during braking. Therefore, the sensor (130) should be placed completely in the marginal wear portion (135) to avoid premature damage caused by heat generation. As the acceptable wear portion (120) wears down, heat will eventually start to reach the sensor (130) such that at some point the sensor (130) will be destroyed. Accordingly, the sensor (130) depth in the wear component is related to the acceptable wear portion (120) reaching its end and the destruction characteristics of the wear component (100).

The sensor (130) provides a condition signal in response to an energizing signal, in which the condition signal indicates that the wear component (100) is within its acceptable wear period. Several suitable sources of the energizing signal will be discussed in more detail below. As the wear surface (110) is worn, the acceptable wear portion (120) becomes thinner and thinner until it is completely worn away. When the acceptable wear portion (120) has worn away sufficiently to expose the sensor (130), the sensor (130) is destroyed. Once the sensor (130) has been destroyed, it no longer provides a condition signal. The absence of the condition signal indicates that the wear component (100) has reached its limit of the acceptable wear portion (120) of the wear component (100). The general function of the wear surface (110) and its interaction with a contact surface (140) will now be discussed in detail, followed by a discussion of the general function of the sensor (130) and its application to the wear component (100).

Wear components are often used in systems which rely on friction in their operation. For example, wheels are able to roll because of the friction between the tires and the pavement. Similarly, brakes generate a stopping force on a wheel due to the friction between the rotating brake rotor coupled to the wheel and the non-rotating brake pad. In such components, the wear surface (110) is worn when it contacts a contact surface (140). In other words, contact between the wear surface (110) and the contact surface (140) wears the outermost portion of the acceptable wear portion (120), or that portion that contacts the contact surface (140).

The amount or thickness of the wear surface (110) that can be worn safely is referred to as the acceptable wear portion (120). The continued use of the wear component (100) causes the acceptable wear portion (120) to become thinner and thinner. At some point, the acceptable wear portion (120) will become so thin that the wear component (100) is no longer acceptable. If some thickness of the acceptable wear portion (120) remains, the wear component (100) is said to be within its acceptable wear period.

While the wear component (100) remains within its acceptable wear period, the sensor (130) remains embedded within the wear surface (110) below the acceptable wear portion (120) at a predetermined depth, depending upon the destructive characteristics of the wear component (100). The sensor (130) receives an energizing signal, such as a radio frequency (RF) energizing signal, from a transmitter (150) which provides the power necessary to operate the sensor (130).

The sensor (130) receives this power and generates a condition signal. A receiver (160) receives this signal and conveys it to a processor (170). The receiver (160) and the processor (170) are located remotely from the sensor (130) and receive the condition signal without a directly wired electrical connection. If the processor (170) receives the condition signal, it determines that the wear component (100) is within its acceptable wear period. While the sensor (130) remains embedded below the acceptable wear portion (120) at a predetermined depth that is dependant upon the destructive characteristics of the wear component (100) and continues to receive an energizing signal, the sensor (130) will continue to generate a condition signal, indicating that the wear component (100) is within its acceptable wear period.

As previously discussed, while the wear surface (110) is worn, the acceptable wear portion (120) becomes thinner and thinner. After a period of wear, the wear surface (110) is reduced to the point that the acceptable wear portion (120) is substantially removed. At that point, the wear component (100) is considered to have reached its minimally acceptable wear period. Further use of the wear component (100) may be marginally safe and eventually become unsafe, as the wear component (100) may not be able to function properly.

As the acceptable wear portion (120) is thus worn away, the sensor (130) becomes exposed to the destructive properties of the wear component (110) and its interacting the contact surface (140). As the sensor (130) is exposed to the properties, it becomes damaged or destroyed. In one embodiment, when the sensor (130) comes into contact with the contact surface (140) it is rendered inoperable such that it no longer transmits a condition signal in response to an energizing signal from the transmitter (150). As previously discussed, while the receiver (160) is receiving a condition signal from the sensor (130), the processor (170) determines that the wear component (100) is within its acceptable wear period.

Similarly, when the receiver (160) is not receiving a condition signal from the sensor (130), the processor (170) is able to determine whether the wear component (100) is within its acceptable wear period. In particular, if the processor (170) determines that the receiver (160) is not receiving a condition signal while the transmitter (150) is providing an energizing signal, the processor determines that the sensor (130) is not operating. If the sensor (130) is not operating, the processor (170) determines that the sensor (130) has been destroyed or damaged by the interaction of the wear surface (110) with the contact surface (140) because the acceptable wear portion (120) has completely worn away. This determination indicates that the wear component (100) has reached its minimally acceptable wear period. The processor (170) then provides an indication that the wear component (100) should be inspected and/or replaced, such as a providing a warning displayed on a human machine interface (HMI) for a predetermined time period so as to be noticeable by the vehicle occupants. The warning may be an audible, visual, or haptic warning or a combination of two or more of these warning signals. Once the predetermined time period expires, in one embodiment, the warning may automatically shut off so as not to create a distraction or annoyance. In another embodiment, an occupant of the vehicle must interact with the HMI to turn the warning off. In yet another embodiment, upon each new ignition cycle (turning the vehicle on), the warning is again issued to the occupants. The warning system also includes a method by which the warning system may be reset once the wear component has been replaced, such that the warning system does not activate until the next sensor (130) in a replacement wear component (100) fails to transmit its condition signal.

The wear component warning system (10) makes use of a sensor placed at a predetermined location within the wear component (100) that is dependent upon the destructive characteristics of the wear component (100). In one embodiment, the sensor (130) is positioned so as to be at least partially below the acceptable wear portion (120) of a wear component (100) that is in communication with a remote processor (170). While the sensor (130) is present in the wear component (100) and transmitting a condition signal, the processor (170) determines that the wear component is within its acceptable wear period. Once the sensor (130) is destroyed or otherwise rendered inoperable, the processor (170) determines that the wear component (100) has reached its minimally acceptable wear period and provides an indication that the wear component (100) should be inspected or replaced. Several wear component warning systems will now be discussed in more detail. These wear component warning systems include both brake pad warning systems and several tire tread wear warning systems.

Brake Pad Warning Systems

FIG. 2 is a simplified view of brake pad warning system (20) in which a brake pad (200) has a radio frequency identification tag (RFID tag) (210) embedded therein. The brake pad warning system (20) monitors the condition of a brake pad (200) without the need for electrical wiring to the RFID tag (210). As shown in FIG. 2, the brake pad (200) includes an acceptable wear portion (220) defined by an acceptable brake pad depth and a marginal wear portion (230) defined by the marginal brake pad depth. The two wear portions (220, 230) are separated by a theoretical marginal depth boundary (240). In one embodiment, the RFID tag (210) is located within the brake pad (200) at a depth such that the RFID tag (21) will become inoperable when the acceptable wear portion (220) is worn away.

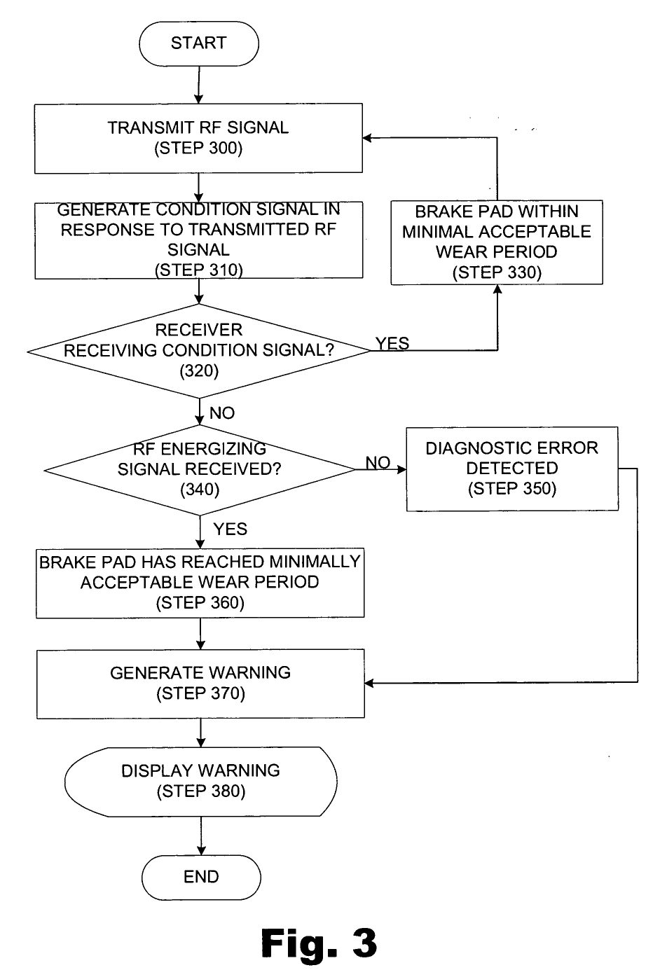

The RFID tag (210) is configured to generate a condition signal in response to an energizing signal such as a RF signal. While the RFID tag (210) is embedded in the brake pad (200) and receiving a RF signal, it will generate a condition signal. A processor is then able to detect the reception or non-reception of the condition signal in determining whether the brake pad (200) is within its acceptable wear period or whether the brake pad (200) should be replaced. If the brake pad (200) should be replaced, the processor is able provide an indication to that effect. A general process for using such a system will be discussed with reference to FIG. 3. Thereafter, the specific exemplary brake pad warning system shown in FIG. 2, as well as several other exemplary brake pad warning systems, will be discussed in more detail.

FIG. 3 is a flowchart summarizing the function of an exemplary brake pad warning system, according to one exemplary embodiment. The functional method begins by sending a RF energizing signal to one or more brake pads having a RFID tag embedded therein (step 300). Several approaches may be used to transmit the RF energizing signal to the RFID tag. Some exemplary approaches for transmitting an RF energizing signal include the use of a dedictated transmitter coupled to a processor, the use of a receiver as part of the processor, and the use of a processor that is part of an existing system, such as a tire pressure monitoring system.

If the RFID tag is functioning, the RF energizing signal powers the RFID tag to generate a condition signal (step 310). This signal is transmitted for reception by a receiver. The receiver is coupled to the processor such that the processor is able to detect whether the receiver is receiving the condition signal (determination 320). If the receiver receives the condition signal transmission (YES, determination 320) the processor determines the RFID tag is intact in the brake pad and consequently the brake pad is within its minimally acceptable wear period (step 330). Thereafter, the system continues to monitor for the brake pad wear by again sending an RF energizing signal and repeating the above process.

If, however, the processor does not detect the condition signal (NO, determination 320), the processor then determines whether a proper RF energizing signal is being transmitted for use by the RFID tag (determination 340). If the processor determines that an RF signal is not being transmitted (NO, determination 340), the processor signals that a diagonstic error has been detected (determination 350) and causes a warning to be generated (step 370).

If the processor determines that an RF energizing signal is being transmitted (YES, determination 340), the processor determines that the RFID tag is not functioning and thus determines the brake pad has reached its minimally acceptable wear period (step 360). Based on this determination, the processor generates an appropriate warning (step 370) which is then displayed on an interface (step 380).

Several approaches may be used for providing an RF signal to the RFID tag according to steps 300-310 and for detecting the receipt or non-receipt of the energizing signal and condition signal according to steps 320 and 340. Several different exemplary systems will be discussed, first with reference to the previously mentioned steps. Further, the above-mentioned method is described with reference to a single RFID tag in a single brake pad. Those of skill in the art will appreciate that any number of RFID tags may be placed in any number of associated brake pads to monitor the wear of multiple brake pads simultaneously, as well as to increase the reliability and robustness of the system.

Returning to FIG. 2, the exemplary brake pad warning system (20) shown in FIG. 2 includes a remote processor (250) that is located within a vehicle. The processor (250) includes an internal transmitter (150) that transmits an RF energizing signal, which is received by the RFID tag (210). The RF energizing signal powers the RFID tag (210) to generate and transmit a condition signal to the processor (250). The processor (250) receives the condition signal via an internal receiver (160). Accordingly, if the processor (250) detects the condition signal in response to transmitting the RF energizing signal, the processor (250) determines that the RFID tag (210) is still operable and thus the brake pad (200) is within its acceptable wear period.

If, however, the processor (250) does not receive a condition signal from the RFID tag (210) in response to the RF energizing signal transmission, the processor (250) determines that the brake pad (200) has worn to the point that the acceptable wear portion (220) has been substantially worn away, thereby rendering the performance of the brake pad (200) marginal. In particular, if the processor (250) does not receive the condition signal in response to the RF energizing signal, the processor (250) determines that RFID tag (210) has been destroyed or otherwise rendered inoperable as the acceptable wear portion is worn away, thus exposing the RFID tag (210) to the descructive properties of the brake rotor's interaction with the brake pad. As a result, the processor (250) determines that the brake pad (200) has reached or surpassed its minimally acceptable wear period. Once the processor (250) detects the absence of the condition signal, the processor provides an appropriate indication to an interface, such as a human machine interface. Several exemplary indication configurations will be discussed later. Presently, more exemplary configurations for providing a RF energizing signal to the RFID tag (210) and for receiving and/or montioring a condition signal generated in response to the RF energizing signal will be discussed.

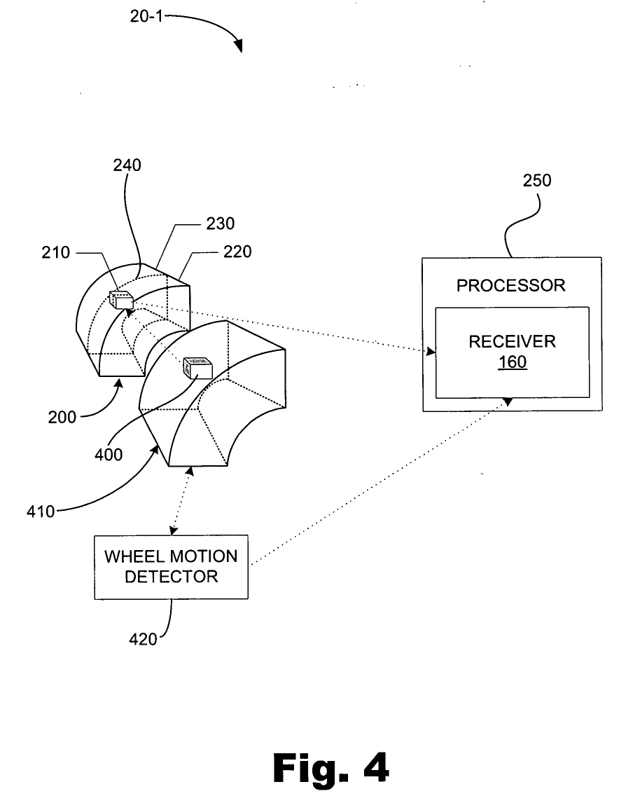

FIG. 4 illustrates an exemplary brake warning system (20-1) in which a RF signal is generated using a magnet (400). As shown in FIG. 4, the magnet (400) is embedded in a rotor (410). The rotor (410) is coupled to a wheel such that as the wheel rotates, the rotor (410) rotates therewith. The magnet (400) is located in the rotor (410) such that as the magnet (400) passes the RFID tag (210), the magnet (400) generates power in the RFID tag (210) via a magnetic field effect caused by the relative motion between the magnet (400) and the RFID tag (210). In particular, as the magnetic field associated with the magnet (400) is passed over the RFID tag (210), a current is generated in the RFID tag (210). The RFID tag (210) then uses the power to generate a condition signal as previously discussed.

The exemplary brake pad warning system (20-1), illustrated in FIG. 4 also includes a wheel motion detector (420). If the wheel motion detector (420) detects that the wheel is in motion, and hence the rotor (410) is in motion, the wheel motion detector (420) sends a wheel motion signal to the receiver (160) in the processor (250). The processor (250) monitors the transmission of the wheel motion signal and the condition signal in parallel. If the processor (250) detects a wheel motion signal, indiciating that the rotor (410) is in motion, the processor (250) checks whether a condition signal has been received. In particular, if the processor (250) does not detect a condition signal within one or more wheel revolutions, the processor (250) determines that the RFID tag (210) is inoperable, as discussed above, and that the brake pad (200) has surpassed its acceptable wear period.

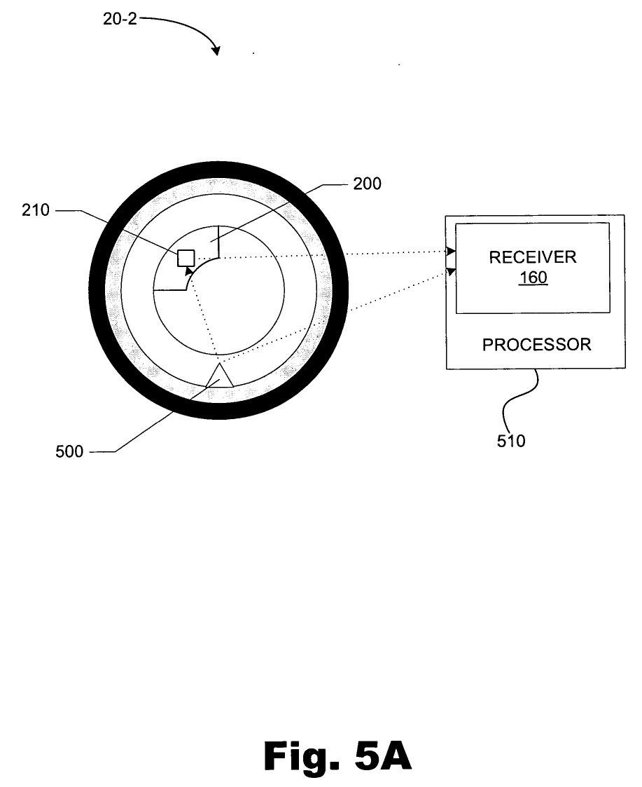

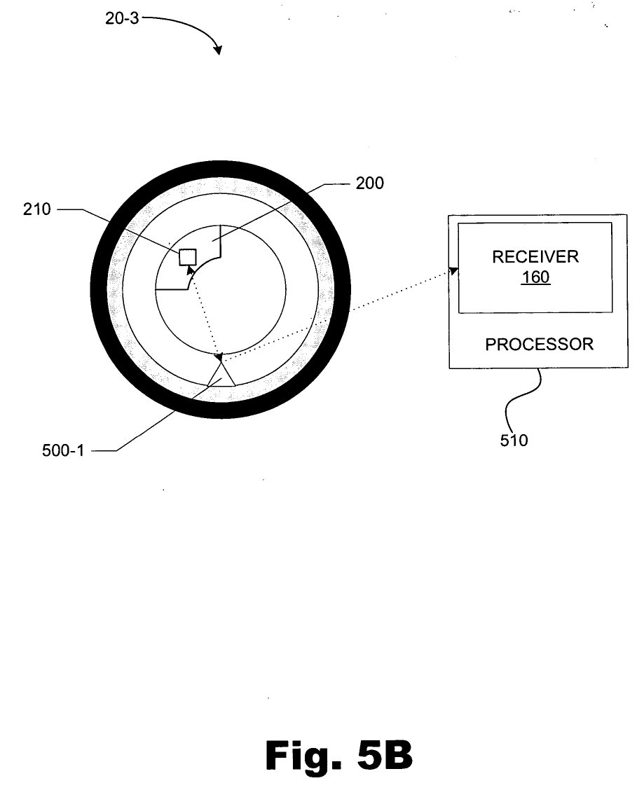

As shown in FIG. 5a, another exemplary brake pad warning system (20-2) makes use of several components of an existing tire pressure monitoring system (TPMS). TMPS systems frequently include a tire pressure sensor (500) that transmits an RF signal that includes information about the air pressure in the tire. The RF signal is then received by a receiver (160) in a processor (510). When the receiver (160) receives the signal, the processor (510) determines whether the tire pressure is within an acceptable range. If the processor (510) determines that the tire pressure is not within an acceptable range, it provides an corresponding warning or indication to a user.

The RFID tag (210) also receives the tire pressure signal. The RFID tag (210) uses RF power carried by the tire pressure signal to generate a condition signal. In addition to processing the tire pressure signal, the processor (510) may be configured to receive and process the condition signal. The processor (510) may be an existing processor that is programmed to process the additional signal. Further, the processor that is responsible to monitor the tire pressure monitoring system, such as the remote keyless entry module, would have additional software to monitor and respond to the additional information transmitted.

Since the transmission of the tire pressure signal powers the condition signal, the processor (510) receives this condition signal at or near the same time as the tire pressure signal. If the processor (510) detects both the tire pressure signal and the condition signal, the processor (510) determines the brake pad (200) is within its acceptable wear period. Similarly, if the processor (510) detects the tire pressure signal but does not detect the condition signal, the processor (510) provides an indication that the tire pressure signal was received without the condition signal and determines that the RFID tag (210) is inoperable, as discussed above, and that the brake pad (200) has surpassed its acceptable wear period.

FIG. 5b illustrates another exemplary brake pad warning system (20-3) that also makes use of several TPMS components. In this system (20-3), the tire pressure sensor (500-1) generates an engerizing signal. The tire pressure sensor (500-1) may also serve as a local receiver and relay the current status of the wear component, such that the tire pressure sensor (500-1) becomes a relay station for the condition signal.

According to the brake pad warning systems discussed with reference to FIGS. 2 and 4-5 above, the warning may be displayed, according to step 380 (FIG. 3) on a human machine interface (HMI) within the vehicle. Consesquently, the warning, when displayed, is visible to a driver while the driver operates the vehicle according to well known designs and principles. Alternatiely the warning may be an audible warning, a visual waring, a haptic warning or a combination of two or more warnings. For example, in addition to making use of the display of an existing tire pressure monitoring system, an end consumer may be provided with a small device that would act as a RF transmitter, RF receiver, and an HMI. The consumer could plug the device into a power source in the vehicle and be instantly notified of the current status of the brake pads (200) as previously described. Further, any HMI may be configured to display which brake pad, if any, has reached its acceptable wear period according to well known diagramming techniques.

In addition to communicating with a processor that is part of a vehicle, the RFID tag (not shown) may interact with a processor outside the vehicle, as shown in FIG. 6. An external device (600) having a processor with RF signal transmitting and receiving capabilities may be used to interact with the RFID tag (not shown) to energize and communicate with the brake pads (200) as previously discussed. In this case, the processor in the external device (600) may include a human machine interface that displays visual warnings or causes any audible warnings communicated thereto by the processor and/or the external device (600) may further interact with a database (610), by which the database (610) stores the information thereon for future reference.

In brief summary, brake pad warning systems include a sensor, such as a RFID tag (210) located at a predetermined location within the wear component based on the destructive properties of the wear component. In one embodiment, because brake pads tend to heat up during braking, the sesor is placed completely in the marginal wear poriton of the brake pad. Initially, the sensor will be deep enough within the brake pad such that heat generation will not adversely impact the seonsor's performance. As the acceptable wear porion is worn down, heat will eventrually start to reach the sensor to the point where the heat generated by the brake pads will destroy or render inoperable, the sensor. While the sensor remains below the acceptable wear portion, the brake pad is within its acceptable wear period. During this period, an RF signal is used to energize the sensor, which causes the RFID tag to transmit a condition signal. The receipt of this condition signal by a receiver indicates that the brake pad is within its acceptable wear period. After the acceptable wear portion of the brake pad is worn away, the sensor becomes exposed to the desctructive properties caused by the interaction of the brake rotor and the brake rotor and is destroyed, thus ending the transmission of the condition signal. When a processor detects the absence of the condition signal, the processor provides a warning that the brake pad has become marginal. As previously discussed, the brake pad warning system is one example of a wear component warning system. Another example of a wear component warning system is a tire wear indicator, which will now be discussed in more detail.

Tire Wear Warning System

As illustrated in FIG. 7, one exemplary wear component warning system includes the use of a tire tread wear warning system (70) that allows the monitoring of tire tread depth without the need of electrical wires. In one embodiment, a tire (700) includes an acceptable tread wear portion (710) and a marginal tread wear portion (720) with an RFID tag (210-1) located therebetween. When the tire tread depth reaches a marginal state, such as when the acceptable tread wear portion (710) is worn away, the RFID tag (210-1) is compromised such that it becomes inoperable. A processor (730) determines that the tire tread has become marginal or that the tire (700) has reached its minimal acceptable wear period when the RFID tag (210-1) is thus rendered inoperable. Once the processor (730) makes this determination, the processor (730) provides an indication to the driver that the tire (700) should be inspected and/or replaced. The indication to the driver of the vehicle may be made via a human machine interface (HMI), such as a tell tale in the instrument cluster of a vehicle, alone or in combination with a chime or other audible signal, or haptic signal.

In the exemplary system shown in FIG. 7, the RFID tag (210-1) is powered by a tire pressure sensor (500), such as that discussed with reference to FIG. 5a. In particular, the tire pressure sensor (500) sends a RF tire pressure signal, which is received by the receiver (160) and is also received by the RFID tag (210-1). As a result, the processor detects the RF tire pressure signal to determine the tire pressure of the tire (700). If the RFID tag (210-1) is still operable, it receives the RF tire pressure signal, which also acts as an energizing signal. This reception energizes the RFID tag (210-1) and allows the RFID tag (210-1) to generate a condition signal, which is also received by the receiver (160). As a result, if the RFID tag (210-1) is operable when the tire pressure sensor (500) is transmitting a tire pressure signal, the RFID tag (210-1) will generate a condition signal. Sensor (500) may also serve as a local receiver and relay the current status of the wear component as dicussed above in connection with FIG. 5b.

The processor (730) uses the receipt or non-receipt of these signals to determine whether the tire (700) has reached its minimally acceptable wear period. For example, if the processor (730) receives both the tire pressure signal and the condition signal, the processor (730) determines that the RFID tag (210-1) is still in place and thus embedded in a predetermined location within the acceptable tread wear portion (710) and that tire is thus within its minimally acceptable wear period.

If instead, the processor (730) determines that the tire pressure sensor (500) is transmitting a tire pressure signal, but that the RFID tag (210-1) is not transmitting a condition signal, the processor (730) determines that the acceptable tread wear portion (710) has been removed and that the tire (700) should be inspected or replaced and provides a warning to that effect.

As shown in FIG. 7 the processor (730) may form a part of a tire pressure monitoring system that is adapted to also process the condition signal. This type of approach would allow the components of the system level to be composed predominantly of software with only a small hardware element, the sensor element 210-1. As a result, the tire tread warning system (70) would leverge the tire pressure monitoring system's communications/software for its own system operation. Further, the processor that is responsible to monitor the tire pressure monitoring system, such as the remote keyless entry module, would have additional software to monitor and respond to the additional information transmitted.

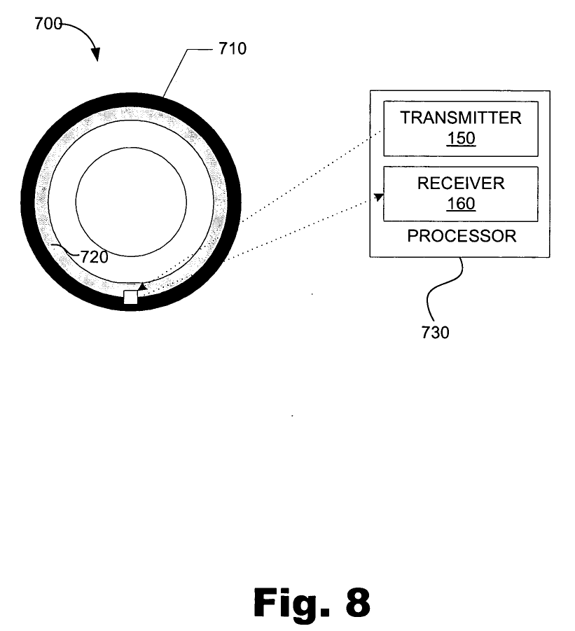

In a similar manner as described above with reference to the brake pad warning systems (20, 20-1, 20-2, 20-3), several approaches are possible for providing an RF signal to the RFID tag (210-1), for receiving the condition signal, and for displaying a warning when the condition signal is not detected. For example, as shown in FIG. 8, the processor (730), which may be located within a vehicle, may include an RF transmitter (150) for transmitting an RF energizing signal and a receiver (160) for receiving the condition signal.

Further, in addition to communicating with a processor that is part of a vehicle, the RFID tag (210-1) may interact with a processor outside the vehicle, in a similar manner as shown in FIG. 6. As a result, tire tread wear could be monitored without necessarily requiring that an HMI be built into the vehicle. From an after-market capability, it would thus be feasible to have dealerships, oil change locations, brake shops, local road infrastructures etc. equipped with devices that could monitor for tire tread communications. For example, when a consumer drives into a location to get his/her oil changed, the service attendant could walk around the vehicle with a RF transmitter/receiver designed to energize and communicate with the tires. If valid state of health messages are established with all tires, that information could be stored in a database for cross reference for the next time the consumer enters his/her shop. If the attendant has communications with only a single tire, then he/she can suggest that the consumer have his tires examined.

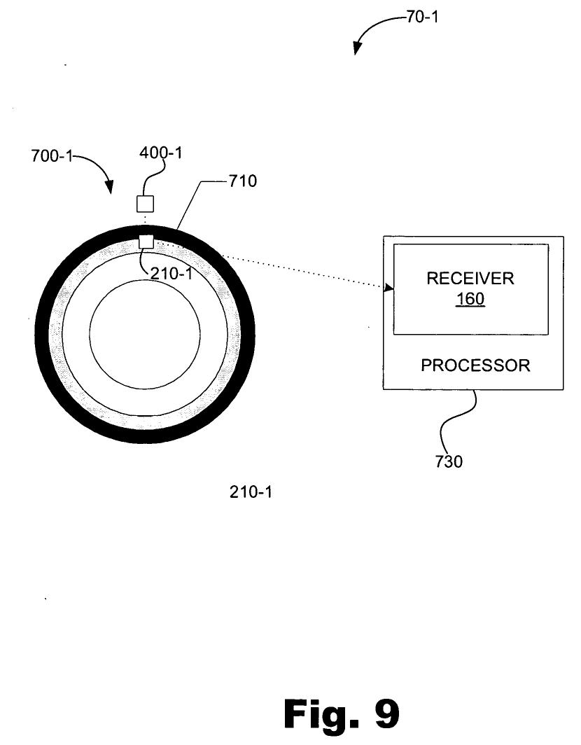

Referring to FIG. 9, in another exemplary embodiment, in a similar manner as described above with reference to the brake pad warning systems of FIG. 4, a tire tread warning system may employ an energizing signal that is generated via a magnetic field. However, as shown in FIG. 9, unlike the brake pad warning system (20-1) that employed a moving magnet (400) and a fixed RFID tag (210), the tire tread warning system (70-1) utilizes a fixed magnet (400-1) because the RFID tag (210-1) is embedded in the tread of the moving tire. As set forth above, a change in the magnetic field experienced by the RFID tag (210-1) can generate electrical current (the energizing signal) which in turn allows the RFID tag (210-1) to generate the condition signal response. In one exemplary embodiment, the magnet (400-1) would be fixed to a location in the wheel well area of the vehicle, near the tire (700-1). As the tire (700-1) rotates past the magnet (400-1), the RFID tag (210-1) would experience a change in the magnetic field which would create electrical current (the energizing signal) and power the RFID tag (210-1) to generate the condition signal.

As shown in FIG. 10, in another exemplary embodiment, the system preferably includes a sign-up process that is used in conjunction with unique IDs associated with each sensor. To start, the system determines whether a learning mode has been selected (determination 1000). This determination is often relevant when the system is first installed. As a result, if the learning mode is not selected (NO, determination 1000) as would frequently be the case in normal operation, the system may operate normally as described with reference to FIG. 3. If the learning mode is selected (YES, determination 1000), the system is then placed in a learning mode (step 1010).

Once the system has been placed in learning mode, each sensor in the system is energized (1020) such that the sensor transmits a condition signal (1030), as previously discussed. The energizing signal may be applied by any of the methods discussed above, including the application of the energizing signal with an external device. For example, an operator could apply an energizing signal to each of the sensors individually to cause each sensor to generate a condition signal. These condition signals each include information unique to the sensor. As a result, the condition signal includes sensor identification information. When the processor receives the condition signal (YES, determination 1040), the processor stores the information (step 1050) and generates some type of feedback (e.g., HMI, horn, lights, etc.) (step 1080) to signify it has learned that sensor's unique ID (step 1050). If the system is to be left in the learning mode (YES, determination 1070), the operator would then move to the next wear sensor in a wear component and learn its unique ID.

If the condition signal is not received (NO, determination 1040), another type of feedback is generated to indicated that the sensor did not transmit a condition signal. According to one exemplary method, the feedback information is displayed through an external energizing device.

In either case, if the system determines that it is to remain in learning mode (1070), the process continues by returning to step 1030 as previously discussed. If the system determines that it is not to remain in learning mode (NO, determintion 1070), the system operates normally according to a process similar to that described with reference to FIG. 3. If the present method is employed, when a sensor fails the processor can not only warn the occupants of an issue, it can convey the specific wear component that is at issue.

In addition, because the sensors are embedded in the wear component, the sensors can also provide a secondary benefit of assisting in inventory control. The manufacturer of the wear component can use the unique IDs to monitor their inventory, as well as verify proper shipments of components to their customers. The customers may also use the IDs to monitor their inventory, verify incoming shipments, assist in building combinations at their respective factories, or even use the unique IDs as part of their manufacturing sequence process.

Additionally, according to one exemplary embodiment, the end consumer could be equipped with a small device that would act as a RF transmitter, RF receiver, and an HMI. The consumer could plug the device into an available power structure of the vehicle and instantly know the status of the tire tread warning system (70) once the device has been properly initialized.

In conclusion, several exemplary wear component warning systems, including brake pad warning systems and tire tread warning systems have been discussed which provide information about the condition of a wear component via sensors embedded therein without having direct electrical wiring to the sensor. As a result, the wear component warning systems allow for the relatively simple and inexpensive monitoring of wear components.

These systems monitor the condition of a wear component by providing an energizing signal, such as an RF signal to a sensor, such as an RFID tag, that is embedded at a predetermined location within the wear portion of the component. While the RFID tag remains operable within the wear component, it will transmit a condition signal in response to the RF signal. A processor then monitors the transmission of the condition signal. When the processor determines that the RFID tag is not transmitting a condition signal in response to the RF energize signal, the processor provides a warning to a user that the wear component should be inspected and/or replaced.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the invention be defined by the following claims.

What is claimed is:

1. A wear component, comprising:
a first wear portion;
a second wear portion; and
a wireless sensor disposed at a predetermined location within said first wear portion, said sensor being configured to generate a condition signal in response to an energizing signal.

2. The wear component of claim 1, wherein said sensor comprises a radio frequency identification tag.

3. The wear component of claim 1, wherein said wear component comprises a brake pad.

4. The wear component of claim 1, wherein said wear component comprises a tire.

5. The wear component of claim 1, wherein said sensor is disposed at least partially below said first wear portion.

6. A wear component warning system, comprising:
a wear component having an acceptable wear portion, a marginal wear portion, and
a sensor disposed at a predetermined depth within said wear component, said predetermined depth being dependant upon the destructive characteristics of said wear component; the sensor being configured to generate a condition signal;
a transmitter configured to provide an energizing signal to said sensor; and
a receiver configured to receive said condition signal and energizing signal.

7. The system of claim 6, wherein said sensor comprises a radio frequency identification tag.

8. The system of claim 6, wherein said transmitter comprises a tire pressure sensor.

9. The system of claim 6, wherein said transmitter comprises a magnet.

10. The system of claim 6, further comprising a processor configured to detect a transmission of said energizing signal by said transmitter and to detect a reception of said condition signal.

11. The system of claim 10, wherein said receiver is integral to said processor.

12. The system of claim 10, wherein said processor is located within a vehicle.

13. The system of claim 10, wherein said processor is external to a vehicle.

14. A brake pad warning system, comprising:
at least one brake pad having an acceptable wear portion, a marginal wear portion, and
a radio frequency identification tag (RFID tag) disposed at a predetermined depth within said brake pad, the RFID tag being configured to generate a condition signal;
a transmitter configured to provide an energizing signal to said RFID tag;
a receiver configured to receive said condition signal and said energizing signal; and
a processor in communication with said transmitter and said receiver.

15. The system of claim 14, wherein said transmitter comprises a magnet.

16. The system of claim 14, wherein said transmitter comprises a tire pressure sensor.

17. The system of claim 16, wherein the tire pressure sensor also serves as a local receiver and relays the current status of a wear component.

18. The system of claim 14, wherein said transmitter is integral to said processor.

19. The system of claim 14, wherein said receiver is integral to said processor.

20. The system of claim 14, wherein said processor is configured to be located within a vehicle.

21. The system of claim 20, wherein said processor is part of a tire pressure monitoring system.

22. The system of claim 14, wherein said processor is part of one of the following systems: a remote keyless entry system, a radio system, or an RF receiver.

23. The system of claim 14, wherein said processor is external to a vehicle.

24. The system of claim 14, further comprising a plurality of said brake pads.

25. The system of claim 14, further comprising a plurality of sensors within a single brake pad.

26. A tire tread warning system, comprising:
at least one tire having an acceptable wear portion, a marginal wear portion, and
a radio frequency identification tag (RFID tag) disposed at a predetermined depth within said tire and configured to generate a condition signal;
a transmitter configured to provide an energizing signal to said RFID tag;
a receiver configured to receive said condition signal and read said energizing signal; and
a processor in communication with said transmitter and said receiver.

27. The system of claim 26, wherein said transmitter comprises a tire pressure sensor.

28. The system of claim 26, wherein the tire pressure sensor also serves as a local receiver and relays the current status of a wear component.

29. The system of claim 26, wherein said transmitter is integral to said processor.

30. The system of claim 26, wherein said receiver is integral to said processor.

31. The system of claim 26, wherein said processor is configured to be located within a vehicle.

32. The system of claim 26, wherein said processor is part of a tire pressure monitoring system.

33. The system of claim 26, wherein said processor is external to a vehicle.

34. The system of claim 26, further comprising a plurality of said tires.

35. The system of claim 26, further comprising a plurality of sensors within a single tire.

36. A method of monitoring a condition of a wear component, comprising:
transmitting an energizing signal to a sensor located with said wear component to cause said sensor to transmit a condition signal;
determining whether said condition signal is transmitted in response to said energizing signal; and
providing a warning if said condition signal is not transmitted in response to said energizing signal.

37. The method of claim 34, wherein said energizing signal is transmitted by magnetic field effects caused by relative movement between a magnet and said sensor.

38. The method of claim 37, wherein said magnet is fixedly secured to the vehicle and said sensor is secured on rotatable element.

39. The method of claim 37, wherein said magnet is imbedded in a rotatable element and the sensor is fixedly secured to the vehicle.

40. The method of claim 36, wherein transmitting said energizing signal comprises transmitting a tire pressure signal from a tire pressure sensor.

41. The method of claim 36, and further comprising the use of a device external to an automobile for transmitting said energizing signal, determining whether said condition signal is transmitted in response to said energizing signal; and providing said warning.
